(19) United States
(12) Patent Application Publication
(10) Pub. No.: US 2019/0267901 A1
(43) Pub. Date: Aug. 29, 2019

(54) Forward Mode Soft Switching Resonant Converter

(71) Applicant: Apple Inc., Cupertino, CA (US)

(72) Inventor: InHwan Oh, Cupertino, CA (US)

(21) Appl. No.: 15/974,008

(22) Filed: May 8, 2018

Related U.S. Application Data
(60) Provisional application No. 62/635,853, filed on Feb. 27, 2018.

(51) Int. Cl. H02M 3/158; H02M 3/06; H02J 50/12; H02J 50/40

(52) U.S. Cl. CPC H02M 3/1588; H02M 3/06; H02M 2001/0058; H02J 50/40; H02J 50/12

(57) ABSTRACT

A forward mode, soft switching, resonant power converter may include a resonant circuit having an input and an output. A main switch may couple the input to a DC input voltage. An auxiliary switch may couple the input to ground. A rectifying component may be coupled between the output of the resonant circuit and an output of the power converter. The main and auxiliary switches may be operated to alternately couple the input terminal to the DC input voltage and ground, thereby converting the DC input voltage to an output voltage of the converter. Resonance may allow for the main and auxiliary switches to be closed under zero voltage switching conditions. The main and auxiliary switches may be operated at a fixed switching frequency, and a duty cycle of the main switch may be increased in response to increased load on the converter.

### BACKGROUND

Conventional LLC resonant converters are so named because they are made up of two inductors (e.g., one resonant inductor and the primary winding of an isolation transformer) and one capacitor. An exemplary LLC resonant converter 100 is illustrated in FIG. 1. In some embodiments, as illustrated, an LLC resonant converter can be constructed having a resonant tank on the primary/input side of an isolation transformer, with the output voltage Vout taken on the secondary/output side of the isolation transformer. In the illustrated LLC resonant converter 100, the resonant tank is composed of capacitor C1, inductor L1, and transformer primary winding P1. Switches Qmain and Qaux may be operated to couple the input terminal of capacitor C1 to an input DC voltage source VDCin and ground. The secondary winding of the isolation transformer may be a center tapped winding, with the output voltage Vout taken from the center tap. Synchronous rectifier switches QSR1 and QSR2 are provided to rectify the voltage appearing at the secondary winding into a DC voltage. (If a single secondary winding is used, four rectifier components are required.) The output voltage Vout of the LLC resonant converter may be controlled by changing the switching frequency of input switches Qmain and Qaux, with their duty cycles fixed at 50%.

LLC resonant converters are sometimes used to convert a fixed/constant high DC input voltage into low DC output voltage. However, there are known drawbacks to this type of converter. For example, in applications where the input voltage (e.g., VDCin) may vary widely, large input voltage ranges can result in corresponding large operating frequency ranges for the switches Qmain and Qaux. This may prove problematic when a very low switching frequency may be required to achieve a high voltage conversion gain when the DC input voltage is low. This reduced switching frequency can cause high magnetizing current, which can substantially increase circulating currents and the associated conduction losses. Additionally, circuit complexity and cost may be increased because of the need for full bridge output rectification, e.g., a center-tapped transformer secondary and two synchronous rectifier switches QSR1 and QSR2 (as shown) or a single secondary winding with a four switch synchronous rectifier (not shown).

Another resonant converter topology is the primary resonant (PR) flyback converter, such as that illustrated in FIG. 2. PR flyback converters may be schematically similar to a simplified LLC resonant converter (as illustrated in FIG. 2), except that they operate in a flyback mode rather than a forward mode. Thus, an input/primary side resonant tank, made up of capacitors C1, L1, and transformer primary winding P1 are alternately coupled to an input DC voltage VDCin and ground by switching devices Qmain and Qaux. Coupling the resonant tank to the input DC voltage causes energy to be stored in the inductance of the flyback transformer. Coupling the resonant tank to ground causes energy to be discharged from the secondary winding of the transformer to the load. (As with the LLC forward converter, a rectification component, e.g., synchronous rectifier QSR1, is required on the secondary side.) PR flyback converters may have switching controlled by a fixed frequency with a variable duty cycle.

PR flyback converters may be used in applications requiring a medium power converter with galvanic isolation between the input and output. However, the physical size of the transformer/coupled windings, which is dictated by the energy transfer requirements, may be a drawback in some applications, particularly those in which galvanic isolation between input and output is not required

Thus, there is a need in the art for a power converter that can provide power for medium to high power loads, from a widely varying input voltage, having reduced circuit complexity, cost, size, and component count.

### SUMMARY

Disclosed herein is a power converter having a resonant circuit, which itself has an input terminal and an output terminal. A main switch may couple the input of the resonant circuit to a DC input voltage of the converter. An auxiliary switch may couple the input of the resonant circuit to ground. The power converter may further have a rectifying component coupled between an output of the resonant circuit and an output of the power converter. The main switch and auxiliary switch may be operated to alternately couple the input of the resonant circuit to the DC input voltage and ground, thereby converting the DC input voltage to an output voltage of the converter. Resonance of the resonant circuit may allow for the main switch and the auxiliary switch to be closed under zero voltage switching conditions.

The resonant circuit may be a series resonant circuit comprising a resonant capacitor, a resonant inductor, and a magnetizing inductor. A first terminal of the resonant capacitor may be the input of the resonant circuit. A junction of the resonant inductor and the magnetizing inductor may be the output of the resonant circuit. The rectifying component may be a diode or a synchronous rectifier. The inductance of the resonant inductor may be much less than the inductance of the magnetizing inductor. The power main switch and the auxiliary switch may be operated at a fixed switching frequency. A duty cycle of the main switch may be increased in response to increased load on the converter.

Also disclosed herein is a wireless power transfer (WPT) circuit having a rectifier configured to receive an AC voltage and convert the received AC voltage to a first DC voltage. The WPT circuit may also include a power converter coupled to the rectifier and configured to convert the first DC voltage to a second DC voltage. The power converter may include a resonant circuit, a main switch configured to selectively couple an input of the resonant circuit and the first DC voltage, an auxiliary switch configured to selectively couple the input of the resonant circuit to ground; and a rectifying component coupled between an output of the resonant circuit and an output of the power converter. The main switch and auxiliary switch may be alternately operated, under zero voltage switching conditions facilitated by resonance of the resonant circuit, to convert the first DC voltage to the second DC voltage. The WPT circuit may also include an inverter coupled to receive the second DC voltage and generate an alternating current voltage delivered to one or more transmitter coils.

Also disclosed herein is a method of operating a power converter having a resonant circuit alternately coupled to a DC input voltage by a main switch and ground by an auxiliary switch. The method can include closing a main switch under zero voltage switching caused by resonance of the resonant circuit, thereby coupling an input of the resonant circuit to the DC input voltage; opening the main switch, thereby allowing the resonant circuit to begin resonating; closing an auxiliary switch under zero voltage switching caused by resonating of the resonant circuit, thereby coupling the resonant circuit to ground; and opening the auxiliary switch, thereby allowing the resonant circuit to continue resonating.

### BRIEF DESCRIPTION OF THE DRAWINGS

FIG. 1 depicts an LLC resonant converter.

FIG. 2 depicts a primary resonant flyback converter.

FIG. 3 depicts a forward mode, soft switching, resonant converter with an output diode.

FIG. 4 depicts a forward mode, soft switching, resonant converter with an output synchronous rectifier.

FIGS. 5A-5D depicts the switching sequence of a forward mode, soft switching, resonant converter.

FIG. 6 depicts various waveforms of a forward mode, soft switching resonant converter.

FIG. 7 depicts a wireless power transfer (WPT) system incorporating a forward mode, soft switching, resonant converter.

FIG. 8 depicts a schematic of a forward mode, soft switching, resonant converter with associated control circuitry.

FIG. 9 depicts a control technique for a forward mode, soft switching, resonant converter.

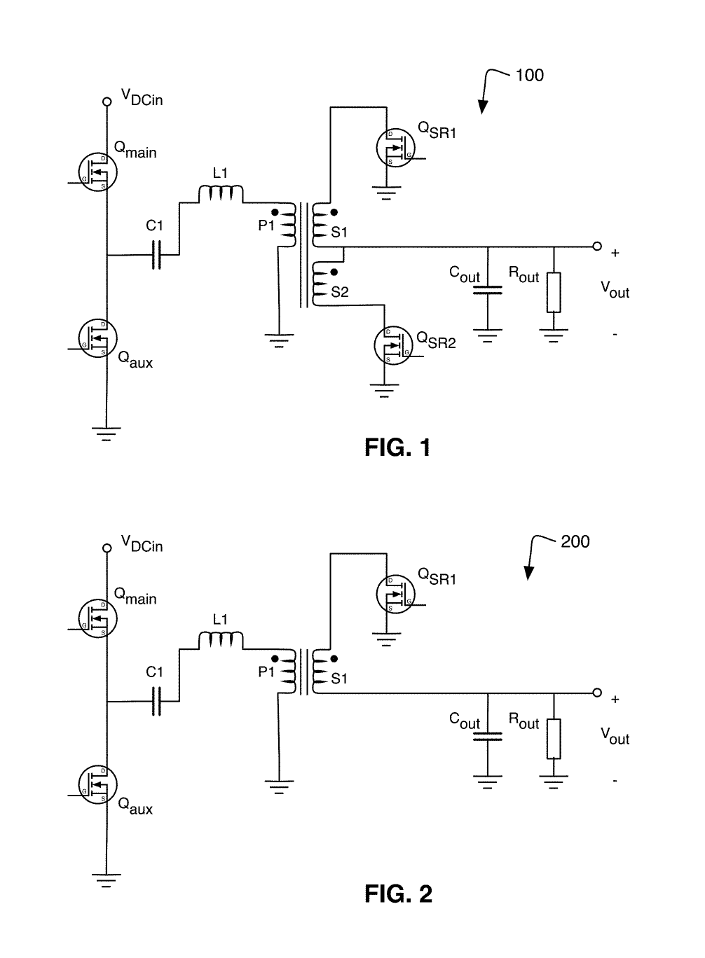

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

Disclosed herein is a forward mode, soft switching, resonant converter. The converter may be operated with a fixed switching frequency to directly convert a high voltage DC input to a low voltage DC output with high efficiency. The disclosed forward mode, soft-switching, resonant converter is a new topology, which incorporates zero voltage switching (ZVS) (for both the primary side control switches and the output side rectification switches) to reduce (i.e., substantially eliminate) switching losses. As a result of the resonant operation and ZVS, high efficiency and high power density can be a achieved in a relatively small form factor. This non-isolated converter may be used in a variety of applications in which it is desirable to get a low DC output voltage from a high DC input voltage with very high efficiency from a simple, low cost circuit. Furthermore, because the disclosed converter's output current is sinusoidal, electromagnetic interference (EMI) may also be substantially reduced.

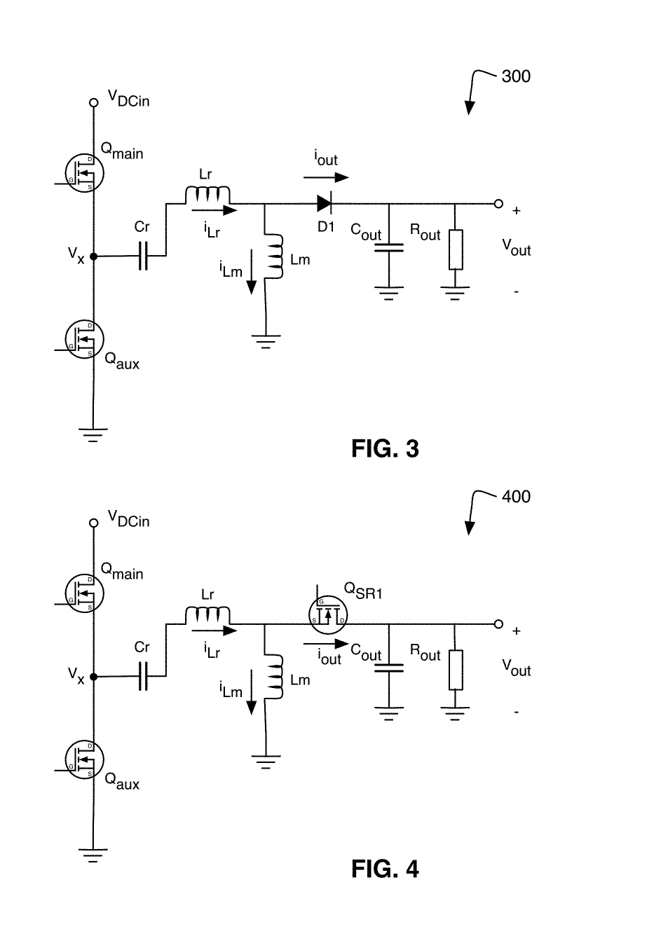

FIG. 3 illustrates an embodiment of a forward mode, soft switching, resonant converter 300. Main switch Qmain may be used to periodically/intermittently couple an input of a resonant tank circuit (described below) to a DC input voltage VDCin. An auxiliary switch Qaux may be operated complimentarily to main switch Qmain (with a suitable dead time). Auxiliary switch Qaux may therefore alternately couple the input of the resonant tank to ground. Switching operation of Qmain and Qaux for the forward mode, soft switching resonant converter is described in greater detail below. The resonant tank circuit may be a series resonant circuit made up of three components: a resonant capacitor Cr, a resonant inductor Lr, and a magnetizing inductor Lm. The junction between the resonant inductor Lr and the magnetizing inductor Lm may be coupled to the output via an output diode D1. The output voltage Vout appears across the output capacitor Cout and the load, which is represented by output resistor Rout. In some embodiments, the output diode D1 may be replaced with synchronous rectifier QSR1 as shown in FIG. 4.

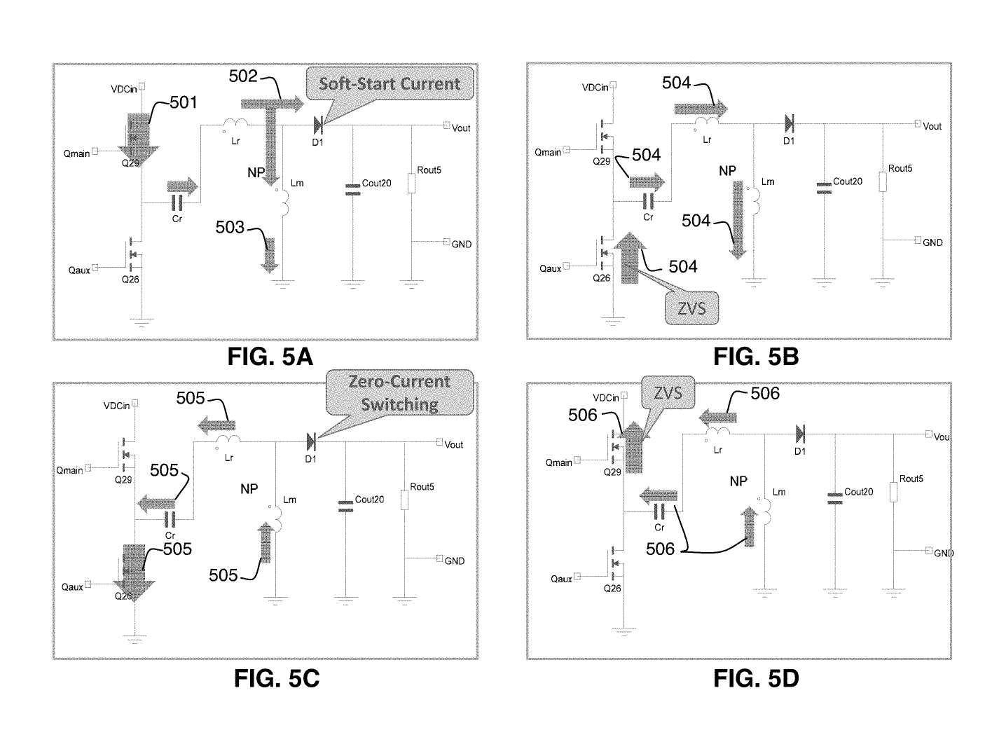

FIGS. 5A-5D illustrate the switching sequence of a forward mode, soft switching, resonant converter, such as those depicted in FIGS. 3 and 4. In some embodiments, the forward mode, soft switching, resonant converter may be operated with a fixed switching frequency (which may be selected to reduce or eliminate electromagnetic interference with other components). The operating frequency may be selected as appropriate for the operating requirements of the system. In some embodiments, the operating frequency may be in the range of 100 kHz to 1 Mhz, although other values could also be used. As a result, increased power demand on the converter may be satisfied by increasing the duty cycle of main switch Qmain (which has the effect of transferring more energy during each switching cycle). This duty cycle may be controlled by monitoring the voltage at the output of the converter or by other suitable control methods known in the art.

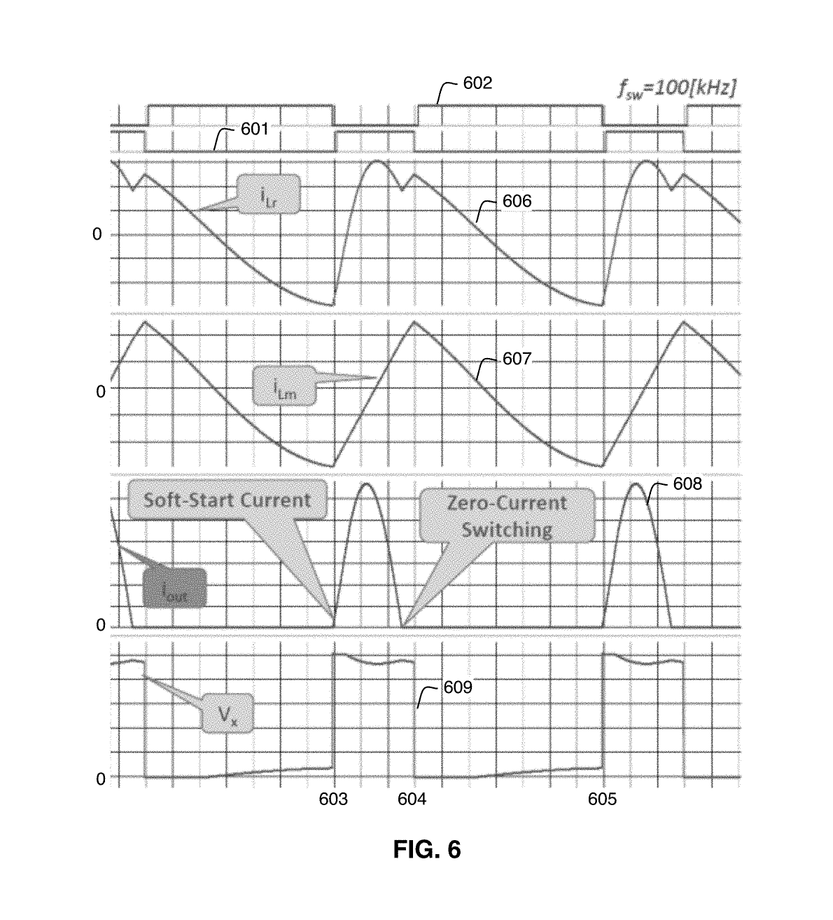

With respect to the switching operations, FIG. 5A illustrates a first stage of the switching sequence in which main switch Qmain is closed. This energizing stage of operation allows a current 501 to flow through main switch, series resonant capacitor Cr, and resonant inductor Lr. This begins the resonating operation of the series resonant circuit. Current 501 then divides into two parts, current 502, which flows through output diode D1 to the output, and magnetizing conductor 503, which flows through magnetizing inductance 503. As described in greater detail below with respect to FIG. 6, the load current 502 is a soft start (i.e., zero current switching), sinusoidal current, which allows for improved noise and EMI performance of the forward mode, soft switching resonant converter.

In some embodiments, resonant inductor Lr may be selected to have an inductance value that much less than the inductance of the magnetizing inductance Lm (i.e., Lr<<Lm). For example, in some embodiments the resonant inductor may have an inductance that is between 1/10th and 1/100^{th} the value of the magnetizing inductance, although other ratios could also be used. As a result, the resonant frequency of the Lr/Cr portion of the circuit may be much higher than the Cr/(Lr+Lm) circuit. This allows for a high resonating current, with a sinusoidal waveform, to be delivered to the load through output diode D1, while a relatively lower resonant current flows through the magnetizing inductor. This magnetizing inductance current iLm (discussed below with respect to FIG. 6) may continue to increase, substantially linearly, for long as main switch Qmain is closed.

Once main switch Qmain is opened, the resonant current 504 follows the current path illustrated in FIG. 5B. More specifically, magnetizing current 504 continues to flow through magnetizing inductance Lm to ground, back through the body diode of auxiliary switch Qaux, through resonant capacitor Cr and resonant inductor Lr. Additionally, because the resonant current through resonant inductor Lr is greater than the resonant current through magnetizing inductor Lm, a current component will continue to flow through output diode D1 to the load during this second switching stage. Because the body diode of Qaux is conducting, the drain to source voltage across auxiliary switch Qaux is zero. This allows auxiliary switch Qaux to be turned on under a zero voltage switching condition, substantially eliminating switching losses associated with this transition.

Once auxiliary switch Qaux is turned on, the resonant operation allows the current through the resonant circuit to reverse, as illustrated by current 505 in FIG. 5C. As a result, current 505 flows in the reverse direction through resonant inductor Lr, resonant capacitor Cr, auxiliary switch Qaux, and magnetizing inductor Lm. This negative magnetizing current 505 continues to increase substantially linearly for so long as auxiliary switch Qaux is turned on. Additionally, because of the current reversal occasioned by the resonant operation of the circuit, the load current will decay to zero and then output diode D1 will become reverse biased, resulting in a zero current switching turn off for output diode D1.

Turning to FIG. 5D, once auxiliary switch Qaux is turned off, the negative magnetizing current follows illustrated current path 506. More specifically, negative magnetizing current 506 flows in the reverse direction through magnetizing inductor Lm, through resonant inductor Lr, resonant capacitor Cr, and the body diode of main switch Qmain. Current flow through the body diode of main switch Qmain results in a drain to source voltage of zero across main switch Qmain. This allows Qmain to be turned on in a zero voltage switching condition, resulting in substantially eliminated switching losses for main switch Qmain. This returns the operating cycle to FIG. 5A, discussed above.

In the switching operations described above, because both high voltage switches (i.e., main switch Qmain and auxiliary switch Qaux) are turned on under a zero voltage switching condition, the switching losses for the converter are negligible. Moreover, because output diode D1 operates with zero current switching and has a sinusoidal current waveform, its capacitive losses are also minimal. As a result, the converter described above can operate with a very high efficiency. Additionally, although the high voltage side of the converter described above uses a series resonant circuit, the two primary side switches have their potential voltage stress effectively clamped by DC input voltage.

FIG. 6 illustrates simulated waveforms for a forward mode, soft switching, resonant converter constructed and operated as described above. Waveform 601 illustrates the gate drive signal for main switch Qmain, with a high signal (e.g., beginning at time 603) indicating that main switch Qmain is closed, and a low signal (e.g., beginning at time 604) indicating that main switch Qmain is open. Waveform 602 illustrates the gate drive signal for auxiliary switch Qaux, with a high signal (e.g., beginning a suitable dead time after Qmain is turned off at time 604) indicating that auxiliary switch Qaux is closed, and a low signal (e.g., beginning at time 605) indicating that auxiliary switch Qaux is open.

Current waveform 606 illustrates resonant inductor current iLr, i.e., the current flowing through resonant inductor Lr. As can be seen, beginning at time 603, when main switch Qmain is switched on, the resonant inductor current increases sinusoidally and then begins to decrease. Once resonant inductor current iLr decreases sufficiently that output diode D1 becomes reverse biased, terminating current flow to the load, the current again increases slightly until main switch Qmain is turned off at time 604. Once main switch Qmain is turned off, the current continues to resonate sinusoidally, now with a somewhat lower frequency (as described above). This continues until time 605, when main switch Qmain is turned on again.

Current waveform 607 illustrates the magnetizing current iLm through magnetizing inductor Lm. As can be seen, beginning at time 603, when main switch is turned on, the magnetizing current iLm increase linearly until time 604. At time 604, when main switch Qmain is turned off, magnetizing current iLm, then resonates. As a result of this resonance, the magnetizing current decays sinusoidally (although nearly linearly) until time 605. At time 605, main switch Qmain is turned on again, and magnetizing current iLm then again increases linearly.

Current waveform 608 illustrates the load current iout that flows through output diode D1 to the load. At time 603, load current iout begins increasing sinusoidally from zero. For output diode D1, this is a zero current switching (ZCS), soft start operation. As noted above, resonant operation of the circuit causes the load current iout to rise and then fall back to zero as a result of output diode D1 being reverse biased, resulting in a second zero current switching event for output diode D1. Load current remains at zero until main switch Qmain is turned on again at time 605.

Voltage waveform 609 illustrates the voltage Vx at the junction of main switch Qmain, auxiliary switch Qaux, and the input terminal of resonant capacitor Cr. This voltage goes from approximately zero volts to VDCin at time 603 when main switch Qmain is closed. This voltage remains at approximately VDCin until main switch Qmain is turned off at time 604 and auxiliary switch Qaux is turned on (after a short dead time to prevent shorting the input power source). Voltage Vx then remains at approximately zero volts until main switch Qmain is turned on again at time 605.

The forward mode, soft switching, resonant converter described above may be used in a variety of power conversion applications. One application that may be particularly suitable for use of such converters is wireless power transfer (WPT) circuits. WPT circuits are increasingly adopted for charging of portable electronic devices such as smartphones, tablet computers, laptop computers, etc. WPT implementations may have a variety of operating constraints that may lend themselves to use of converters like that described herein. For example, WPT circuits are beginning to be used in moderate to high power applications, for example, ranging from 60 to 70 watts. Additionally, WPT circuits may be used in applications in which the input voltage can vary widely, e.g., from 90V to 265V. This may correspond to DC voltage variations from 90V to 375V. It is desirable for such circuits to operate as efficiently as possible, which may be achieved by achieving soft switching across the entire range of operating voltages as described above. Additionally, because a WPT circuit relies on inductive coupling between the transmitter coil and receiver coil, such circuits may be constructed without their own source of galvanic isolation.

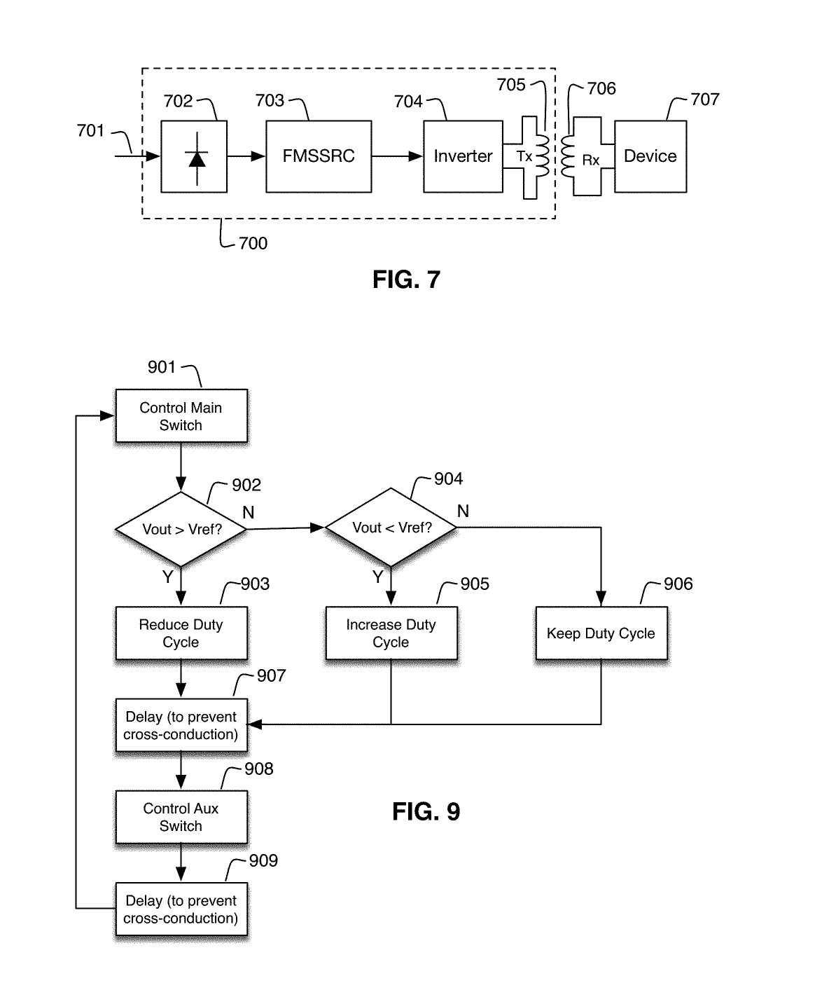

An exemplary wireless power transfer circuit 700 incorporating a forward mode soft switching resonant converter is illustrated in FIG. 7. Wireless power transfer circuit 700 may be configured to receive a relatively high and potentially variable AC input voltage 701. This AC input voltage may be rectified into a relatively high DC voltage by rectifier 702. The relatively high (rectified) DC voltage may be passed to a forward mode, soft switching resonant converter 703, which may be constructed as described above with respect to FIGS. 3-6. Forward mode, soft switching resonant converter 703 may produce a relatively lower DC output voltage that is passed to an inverter 704. Inverter 704 may be of any of a variety of types, such as a full bridge inverter, that may be used in conjunction with wireless power transfer circuits. Typically these circuits operate with frequencies in the hundreds of kilohertz range, and with voltages that are selected as a function of power transfer requirements and magnetic coupling limitations. Finally, the output of inverter 704 is coupled to a transmit coil 705, which may wirelessly transmit power to a device 707 that incorporates a suitable receiver coil 706. Some wireless power transfer systems may include a plurality of transmit coils 705. Within device 706 may be other electronic components, such as rectifiers (for the induced AC voltage) chargers, voltage regulators, etc. In some embodiments, the inverter 704, transmit coil 705, receiver coil 706, and various components of device 707 may be constructed to operate in conjunction with various wireless power transfer standards, for example the Qi wireless charging standard promulgated by the Wireless Power Consortium (“WPC”).

FIG. 8 illustrates a schematic of a forward mode, soft switching, resonant converter including exemplary control circuitry. Circuit block 801 may be a forward mode, soft switching, resonant converter as described above. Main switch Qmain and auxiliary switch Qaux are operated by a gate driver circuit 802, which receives as an input the output of the control circuit as described in greater detail below. Additionally, current sensor 803 monitors the current through resonant inductor Lr, and output voltage sensor 804 monitors the output voltage appearing across output capacitor Cout. The sensed current and voltage are the inputs into the control circuit.

More specifically, the output voltage sensed by output voltage sensor 804 acts as a feedback signal, which is compared to a reference voltage 805 by summer 806. The resulting error signal (i.e., the reference voltage minus the output voltage) is input into a control loop 807, which may be, for example, a proportional-integral-derivative control loop, although other control methodologies could also be used. The output of control loop 807 is input into comparator 808, which also receives a current signal from current sensor 803. Once the current through resonant inductor (sensed by current sensor 803) reaches a predetermined value, or once the output voltage (sensed by output voltage sensor 804) exceeds the reference 805, the output of comparator 808 transitions high. The output of comparator 808 is fed into OR gate 809 and a high output results in a reset of flip flop 812. This triggers gate drive 802 to open main switch Qmain.

Concurrently, the current through series inductor Lr, sensed by current sensor 803 is input into comparator 811. Comparator 811 compares the sensed current to an overcurrent protection reference value 810. The output of comparator 811 is coupled to OR gate 809, discussed above with respect to the voltage control loop. If the current through series inductor Lr exceeds the overcurrent protection threshold, then the output of comparator 811 transitions high. This triggers a reset of flip flop 812, which, in turn, causes gate drive 802 to open main switch Qmain.

Flip flop 812 may be an S-R type flip flop, which has its S or “set” input coupled to a clock 813 that determines the switching frequency of the converter. A high input from clock 813 on the S terminal of flip flop 812 will cause flip flop output Q to transition high, closing main switch Qmain, as described further below. The R or “reset” input of flip flop 812 may receive the signal from OR gate 809 discussed above, which triggers opening of the main switch Qmain. As described above, a high input at the R terminal (from OR gate 809) will reset the flip flop, causing flip flop output Q to transition low, opening main switch Qmain, as described further below. The Q or “output” terminal of flip flop 812 may be coupled to gate drive 802. Gate drive 802 may be configured to close main switch Qmain (and open auxiliary switch Qaux) when it receives a high input and to open main switch Qmain (and close auxiliary switch Qaux) when it receives a low input. In both cases, gate drive circuit 802 may implement a suitable short delay between opening one switch and closing the other to prevent cross, conduction, which would short out the input power source.

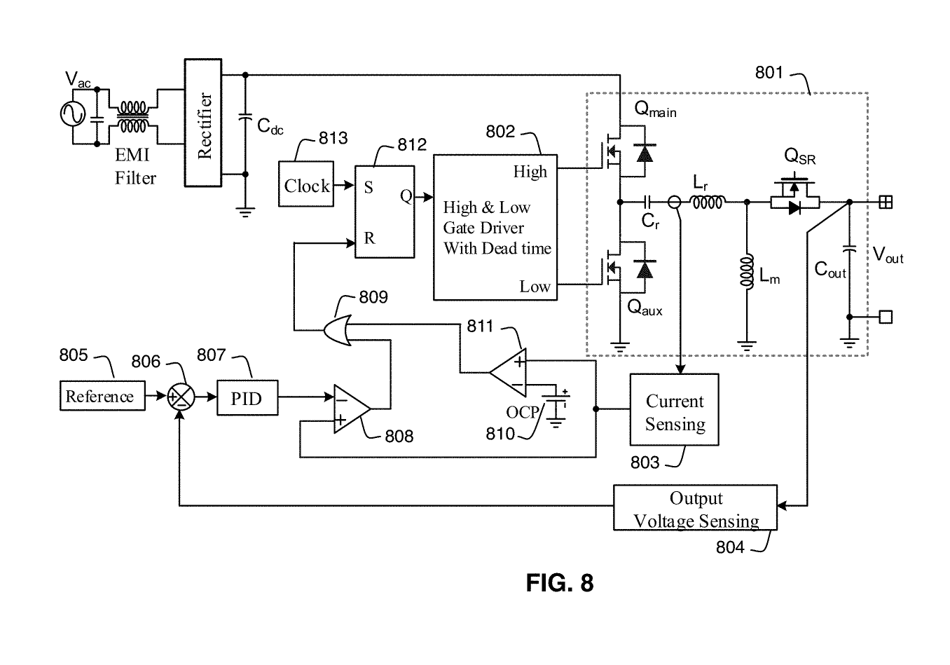

FIG. 9 illustrates a simplified flow chart of the operating sequence of the forward mode, soft switching, resonant converter described above. At the beginning of the switching cycle, the main switch may be operated (901). As described above, closing initiates the resonant operation described above with respect to FIG. 5A, and closing the main switch is a zero voltage switching operation caused by operation of the resonant circuit. Opening main switch (FIG. 5B), the timing of which is determined by the main switch duty cycle (discussed below) completes the main switch control cycle 901.

Then, the output voltage may be compared to the reference voltage (902, 904). If the output voltage is greater than the reference voltage, the main switch duty cycle may be reduced (903). If the output voltage is less than the reference voltage, the main switch duty cycle may be increased (905). Otherwise, the main switch duty cycle may be kept constant (906).

After a suitable delay time (907) to prevent cross conduction of the main and auxiliary switches, the auxiliary switch control cycle (908) may be commenced. Closing and opening of the auxiliary switch may be as described above with respect to FIGS. 5C-5D, with the timing dictated by the selected duty cycle. After auxiliary switch closes, terminating auxiliary switch control cycle 908, and after a suitable delay to prevent cross conduction (909), the control cycle may repeat with the main switch control cycle 901.

Described above are various features and embodiments relating to forward mode, soft switching, resonant converters. Such converters may be used in a variety of applications, but may be particular advantageous when used in conjunction with wireless power transmission systems and/or other power adapter solutions for use in conjunction with portable electronic devices such as mobile telephones, smart phones, tablet computers, laptop computers, media players, and the like, as well as the peripherals associated therewith. Such associated peripherals can include input devices (such as keyboards, mice, touchpads, tablets, microphones and the like), output devices (such as headphones or speakers), combination input/output devices (such as combined headphones and microphones), storage devices, or any other peripheral.

Additionally, although numerous specific features and various embodiments have been described, it is to be understood that, unless otherwise noted as being mutually exclusive, the various features and embodiments may be combined in any of the various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A power converter comprising:
a resonant circuit having an input and an output;
a main switch coupled to the input of the resonant circuit and a DC input voltage of the converter;
an auxiliary switch coupled to the input of the resonant circuit and to ground; and
a rectifying component coupled between the output of the resonant circuit and an output of the power converter;
wherein the main switch and the auxiliary switch are operated to alternately couple the input of the resonant circuit to the DC input voltage and ground, thereby converting the DC input voltage to an output voltage of the converter; and
wherein the main switch and the auxiliary switch are closed under zero voltage switching conditions.

2. The power converter of claim 1 wherein the resonant circuit is a series resonant circuit comprising a resonant capacitor, a resonant inductor, and a magnetizing inductor.

3. The power converter of claim 2 wherein a first terminal of the resonant capacitor is the input of the resonant circuit.

4. The power converter of claim 2 wherein a junction of the resonant inductor and the magnetizing inductor is the output of the resonant circuit.

5. The power converter of claim 4 wherein the rectifying component is a diode.

6. The power converter of claim 4 wherein the rectifying component is a synchronous rectifier.

7. The power converter of claim 2 wherein the inductance of the resonant inductor is much less than the inductance of the magnetizing inductor.

8. The power converter of claim 1 wherein the main switch and the auxiliary switch are operated at a fixed switching frequency.

9. The power converter of claim 8 wherein a duty cycle of the main switch is increased in response to increased load on the converter.

10. A wireless power transfer circuit comprising:
a rectifier configured to receive an AC voltage and convert the received AC voltage to a first DC voltage;
a power converter coupled to the rectifier and configured to convert the first DC voltage to a second DC voltage, the power converter comprising:
a resonant circuit;
a main switch configured to selectively couple an input of the resonant circuit to the first DC voltage;
an auxiliary switch configured to selectively couple the input of the resonant circuit to ground; and
a rectifying component coupled between an output of the resonant circuit and an output of the power converter;
wherein the main switch and auxiliary switch are alternately operated, under zero voltage switching conditions facilitated by resonance of the resonant circuit, thereby converting the first DC voltage to the second DC voltage;
an inverter coupled to receive the second DC voltage and generate an alternating current voltage delivered to a transmitter coil.

11. The wireless power transfer circuit of claim 10 comprising a plurality of transmitter coils.

12. The wireless power transfer circuit of claim 10 wherein the resonant circuit is a series resonant circuit comprising a resonant capacitor, a resonant inductor, and a magnetizing inductor.

13. The wireless power transfer circuit of claim 10 wherein the rectifying component is a diode.

14. The wireless power transfer circuit of claim 10 wherein the rectifying component is a synchronous rectifier.

15. The wireless power transfer circuit of claim 12 wherein the inductance of the resonant inductor is much less than the inductance of the magnetizing inductor.

16. The wireless power transfer circuit of claim 10 wherein the main switch and the auxiliary switch are operated at a fixed switching frequency.

17. The wireless power transfer circuit of claim 10 wherein a duty cycle of the main switch is increased in response to increased load on the converter.

18. A method of operating a power converter having a resonant circuit alternately coupled to a DC input voltage by a main switch and ground by an auxiliary switch, the method comprising:
closing a main switch under zero voltage switching caused by resonance of the resonant circuit, thereby coupling an input of the resonant circuit to the DC input voltage;
opening the main switch, thereby allowing the resonant circuit to begin resonating;
closing an auxiliary switch under zero voltage switching caused by resonating of the resonant circuit, thereby coupling the resonant circuit to ground;
opening the auxiliary switch, thereby allowing the resonant circuit to continue resonating.

19. The method of claim 18 wherein operation of the main and auxiliary switches takes place at a fixed frequency.

20. The method of claim 19 wherein a duty cycle of the main switch is increased in response to increased load on the converter.
